(19) United States
(12) Patent Application Publication
(10) Pub. No.: US 2015/0348447 A1
(43) Pub. Date: Dec. 3, 2015

(54) TROPHY WITH REMOVABLE BAND

(71) Applicant: Trend International Group Limited, Tyne & Wear (GB)

(72) Inventor: Jason Bushby, Tyne & Wear (GB)

(21) Appl. No.: 14/724,137

(22) Filed: May 28, 2015

(30) Foreign Application Priority Data
May 28, 2014 (GB) 1409400.7
Dec. 16, 2014 (GB) 1422346.5

(51) Int. Cl. G09F 3/02; A47G 33/00

(52) U.S. Cl. CPC G09F 3/02; A47G 33/004; G09F 2003/0251

(57) ABSTRACT

A trophy is provided with a removable stretchable band mounted on the trophy base. The trophy comprises indicia indicating the position where the stretchable band is to be mounted on the trophy and an element providing for lifting of the band from the trophy.

### FIELD OF THE INVENTION

The present invention relates to trophies and in particular to a trophy having a removable adornment.

### BACKGROUND OF THE INVENTION

Trophies have been awarded as prizes since time immemorial. They are typically awarded to the winners of competitions or to individuals who have accomplished a particular feat. A trophy provides a physical reminder of the effort and achievement made by an individual or team.

Trophies are often displayed. Individuals may display trophies for their personal viewing, or they may display them more prominently so that visitors may view them. It is not uncommon for trophy cabinets to be constructed to house and display trophies.

However, trophies are not items that can be kept about the person and hence cannot provide a constant reminder of an individual's achievement.

It has become common to issue participants in events with stretchable wrist bands. Such bands may be issued to all participants or only to participants achieving a certain level. Special bands may be awarded to the winner or placed participants in an event.

It would be desirable to provide a stretchable band award that is associated with a trophy. This would provide a number of advantages. First, the stretchable band associated with the trophy would stand out from other bands that might be awarded to participants at an event. Second, the colour of the band may be selected to match the colours of the event and thereby provide a convenient and cost effective way of customising a generic trophy to a particular event. Third, the trophy may provide a convenient place to keep the stretchable wrist band when it is not being worn.

U.S. Pat. No. 4,713,900 describes a bowl to which a sporting emblem may be attached. The sporting emblem may be mounted on a stretchable belt that sits in a groove.

US2012/0055964 describes a container that has a groove therein. A wrist band sits in the groove.

US2008/0149589 describes a container with a groove therein and a stretchable band. The container is formed so as to receive an object such as a mobile phone which is attached to the container by the stretchable band.

It would be desirable to provide a trophy with a removable stretchable band and to facilitate the easy removal of the band from the trophy.

### SUMMARY OF THE INVENTION

According to the invention there is provided a trophy having a stretchable band mounted thereon.

Preferably, the stretchable band is a continuous stretchable band. More preferably, the stretchable band is a silicone band, such as silicone rubber. Even more preferably, the stretchable band has adornments provided thereon. The adornments may be letters or symbols and may be moulded integrally with the stretchable band. Adornments may be printed on to the stretchable band.

Advantageously, the trophy is provided with indicia indicating the position where the stretchable band is to be mounted on the trophy. The indicia may take the form of a line, or a plurality of spaced apart lines, which preferably lie parallel with one another.

The trophy may include a band seat. The indicia may take the form of at least one raised portion. The at least one raised portion and the band seat may form a channel extending around a part of the trophy, the channel configured to receive the stretchable band.

The channel may be in the base of the trophy, an upper part of the trophy, a mid part of the trophy, a rear part of the trophy or a projecting part of the trophy.

The trophy may further include an element providing for lifting of the band from the trophy. The element is an indent and may be formed in the band seat and preferably in the channel. However, the element could be one or more protrusions extending outward from the surface of the trophy and allowing a finger to be inserted between the band and the trophy to remove the band therefrom.

Advantageously, the trophy and stretchable band are configured such that with the stretchable band mounted on the trophy the stretchable band is under tension.

The trophy may be made from any suitable material or combination of materials. For example, the trophy may comprise one or more of the following materials: metal, marble, resin, wood or glass.

### BRIEF DESCRIPTION OF THE DRAWINGS

In the Drawings, which are by way of example and show preferred embodiments of a trophy with a removable band according to the invention:

FIG. 1 is a schematic representation of the stretchable band;

FIG. 2 is a schematic representation of a trophy base;

FIG. 3 illustrates the trophy base of FIG. 2 with the stretchable band of FIG. 1 mounted thereon;

FIG. 4 is a front view of the trophy without the stretchable band;

FIG. 5 is a side view of the trophy without the stretchable band;

FIG. 6 is a rear view of the trophy illustrated in FIGS. 4 and 5 and stretchable band;

FIG. 7 is a front view of a different embodiment of the invention where the stretchable band is mounted on an upper part of the trophy;

FIG. 8 is a front view of the part of the trophy shown in FIG. 7 without the stretchable band;

FIG. 9 is a schematic representation showing the upper part illustrated in FIG. 7 with the stretchable band mounted thereon;

FIG. 10 is a side view of another alternative embodiment of the invention;

FIG. 11 is a schematic representation of the lower part of the trophy illustrated in FIG. 10;

FIG. 12 is another schematic representation of the lower part of the trophy illustrated in FIGS. 10 and 11;

FIG. 13 is a front view of a trophy of another embodiment of the invention;

FIG. 14 is side view of the trophy illustrated in FIG. 13;

FIG. 15 is a schematic representation of the trophy illustrated in FIGS. 13 and 14 with the stretchable band attached thereto;

FIG. 16 is a front view of a trophy according to another embodiment of the invention;

FIG. 17 is a side view of the trophy illustrated in FIG. 16;

FIG. 18 is a schematic representation of a part of the trophy illustrated in FIGS. 16 and 17;

FIG. 19 is a schematic illustration of a trophy according to another aspect of the invention;

FIG. 20 is a schematic illustration of a part of the trophy illustrated in FIG. 19;

FIG. 21 is a schematic illustration of a trophy according to another aspect of the invention.

### DETAILED DESCRIPTION OF THE PREFERRED EMBODIMENTS

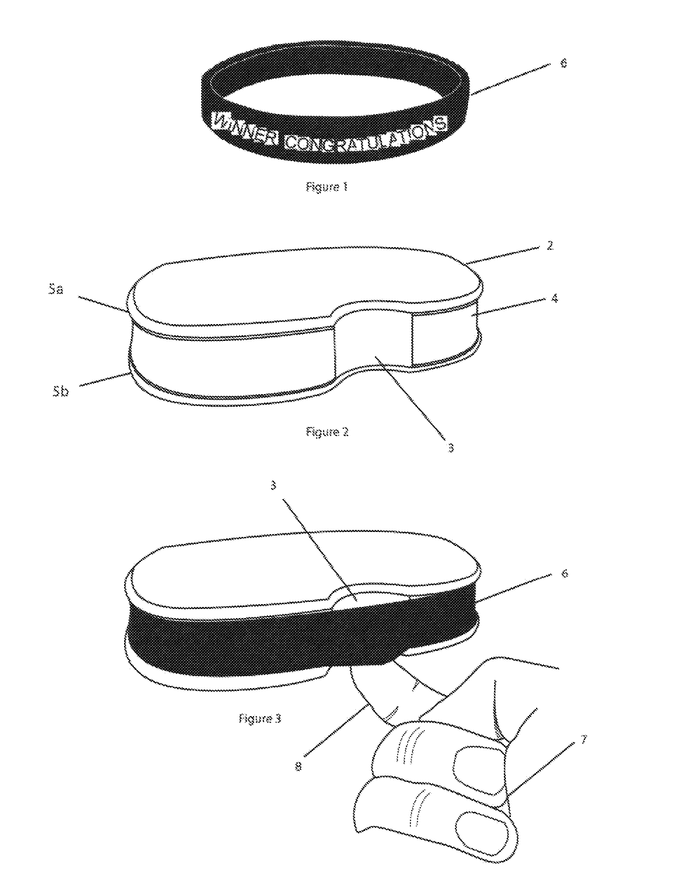

FIG. 1 illustrates a stretchable band 6, which in the present invention is a stretchable silicone rubber.

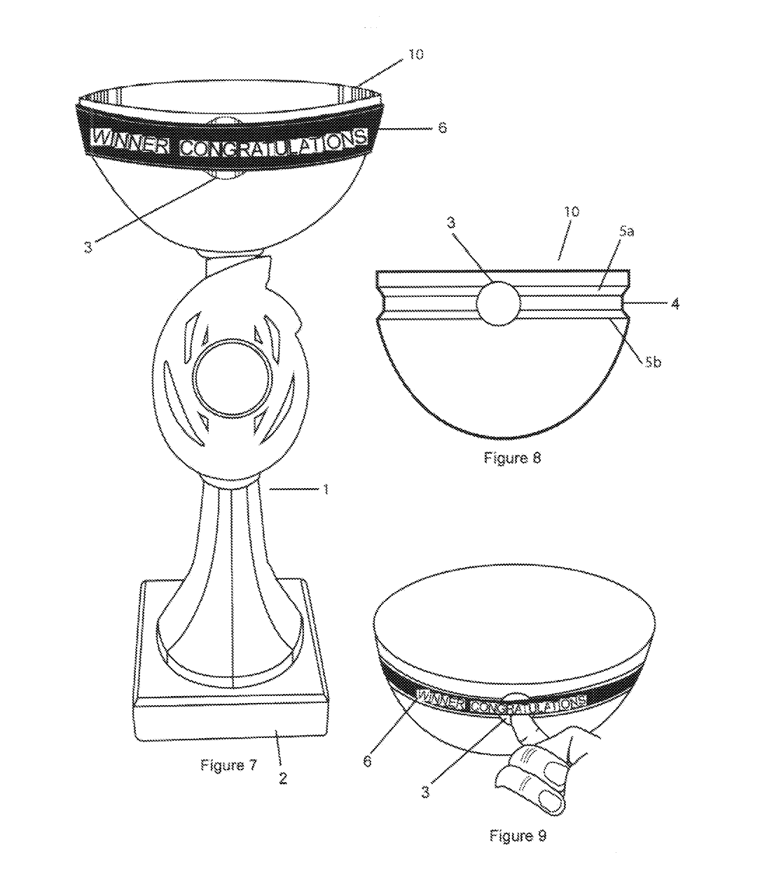

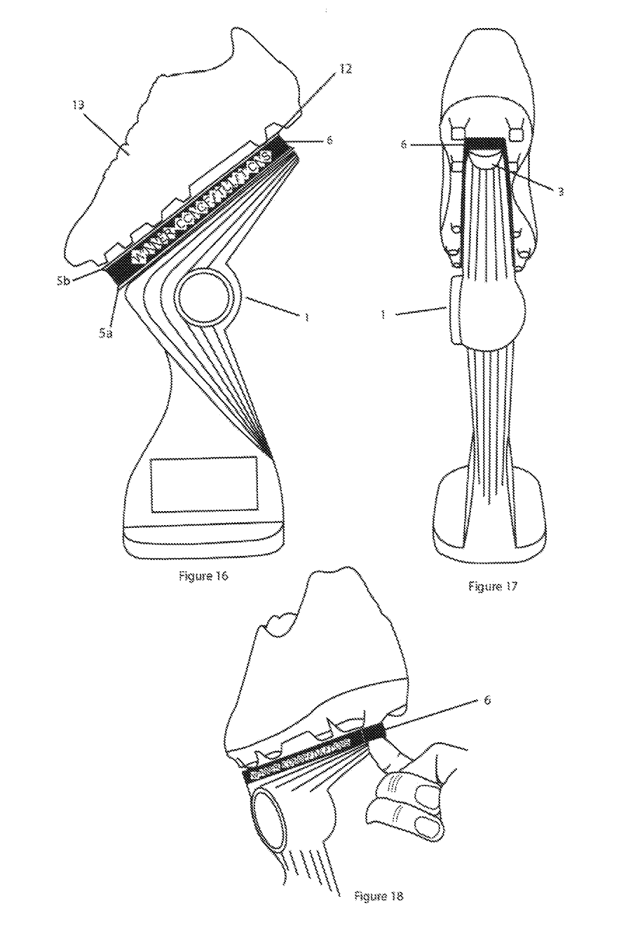

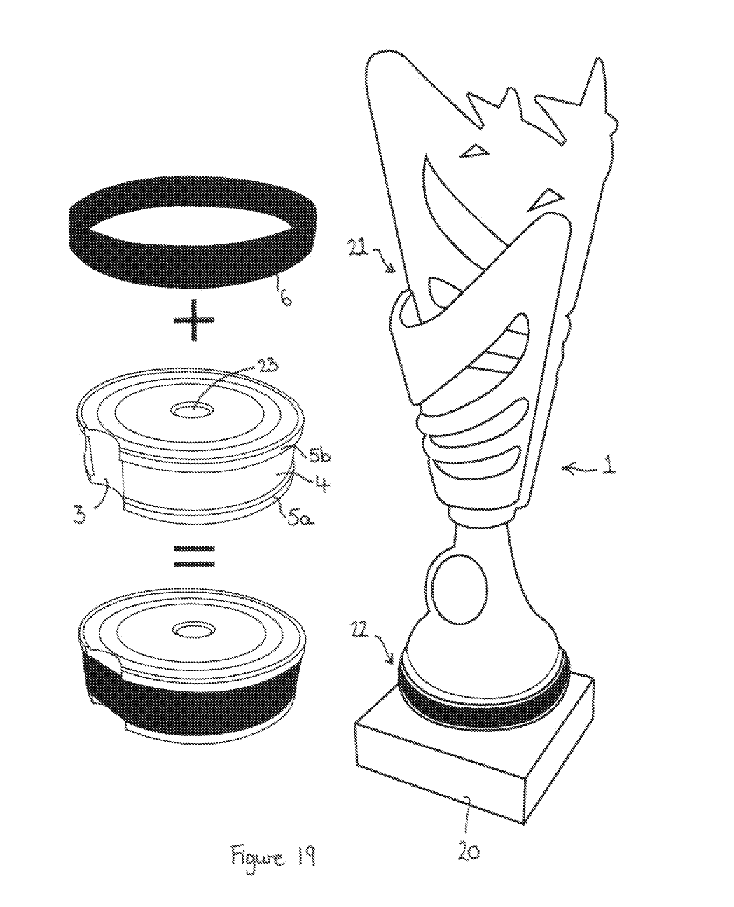

FIG. 2 illustrates a base 2 which typically forms part of a trophy as shown in FIGS. 4 to 18. The base 2 includes a channel 4 bound by spaced apart lips 5a, 5b. The base 2 also includes an indent 3.

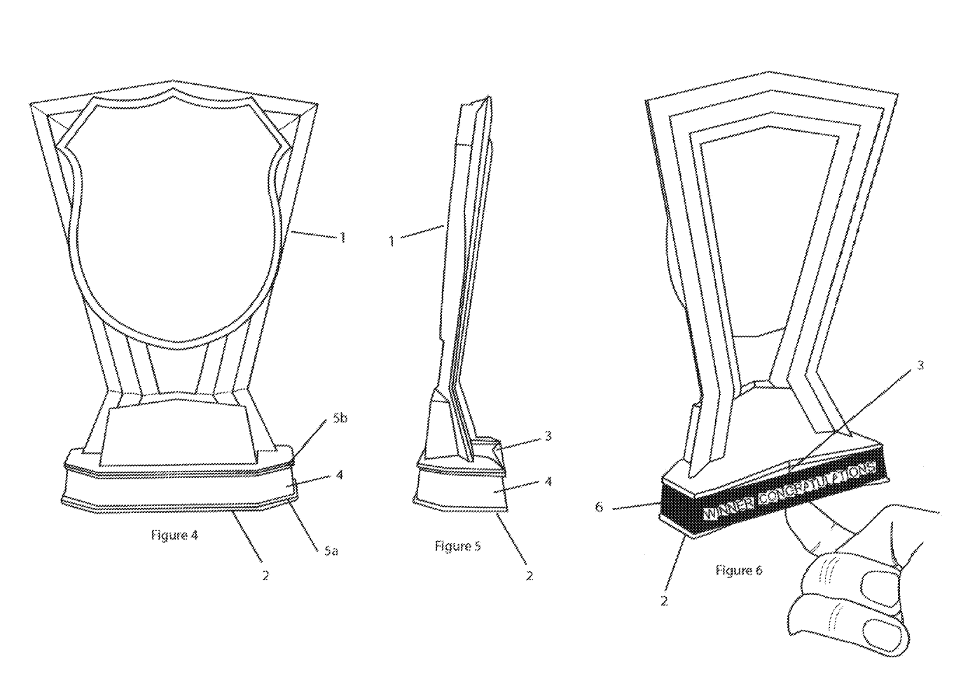

FIG. 3 illustrates the base 2 with the stretchable band 6 mounted thereon. It can be seen that the band 6 sits in the channel 4. FIG. 3 also illustrates a person's hand 7. It can be seen that the indent 3 allows a finger 8 of the hand to be inserted behind the band 6 in order that it may be easily removed from the base 2.

Referring now to FIGS. 4 to 6, there is shown a trophy 1 having a base 2 and the stretchable band 6.

The base 2 provides a channel 4 in which the band 6 is mounted. The channel is formed by two spaced apart lips 5a, 5b which lie substantially parallel with one another, and extending substantially perpendicular to a base of the channel 4.

It will be appreciated that in the present example the base of the channel lies off the vertical plane. It will also be appreciated that the stretchable band is sufficiently stretchable to take up the difference in the perimeter formed around the base of trophy in the region of the lower lip 5a and upper lip 5b respectively, without the band 6 becoming creased.

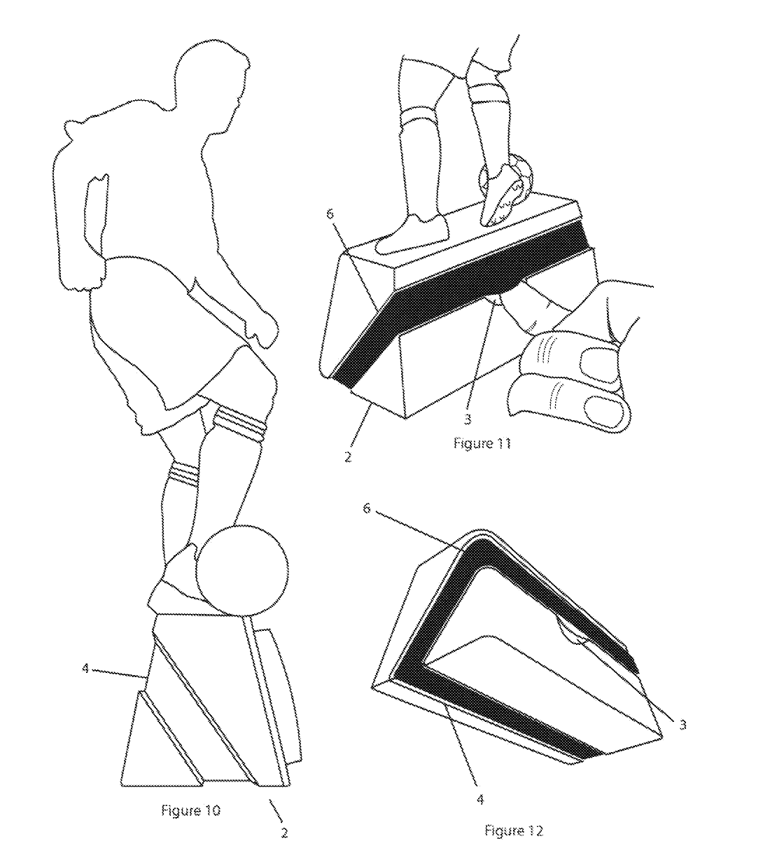

FIGS. 7 to 9 illustrate an embodiment of the invention where the stretchable band 6 is mounted on an upper part 10 of the trophy 1, which in the present example is a bowl. A channel bound by parallel walls 5a, 5b, receives the band 6. As can be seen from FIG. 9 in particular, an indent 3 allows a finger 8 to be inserted behind the band 6 in order to remove the band from the trophy 1.

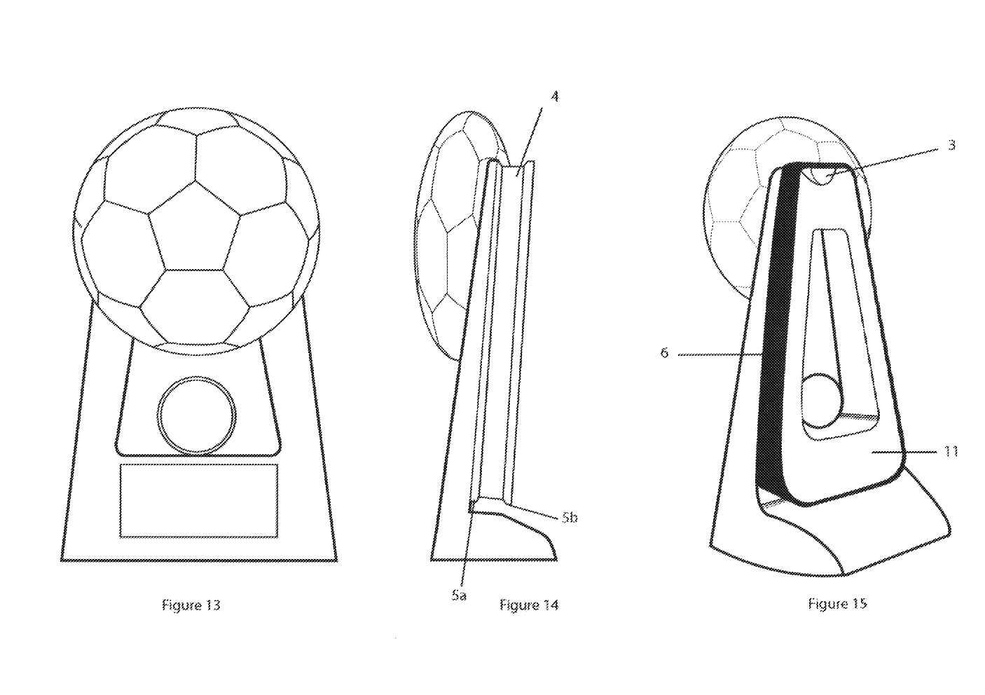

FIGS. 10 to 12 illustrate another alternative embodiment of the invention where the channel 4 is formed in the base 2 to the underside and rear thereof. An indent 3 is provided to allow a finger to be inserted behind the band 6 to lift the band from the base 2.

FIGS. 13 to 15 illustrate another alternative embodiment of the invention where the band 6 is mounted on an element 11 projecting rearwardly from the back of the trophy 1. A channel 4 bound by lips 5a, 5b receives the band 6, and an indent 3 conveniently positioned in the upper part of the element 11 allows a finger to be inserted underneath the band 6 so that the band may be lifted therefrom.

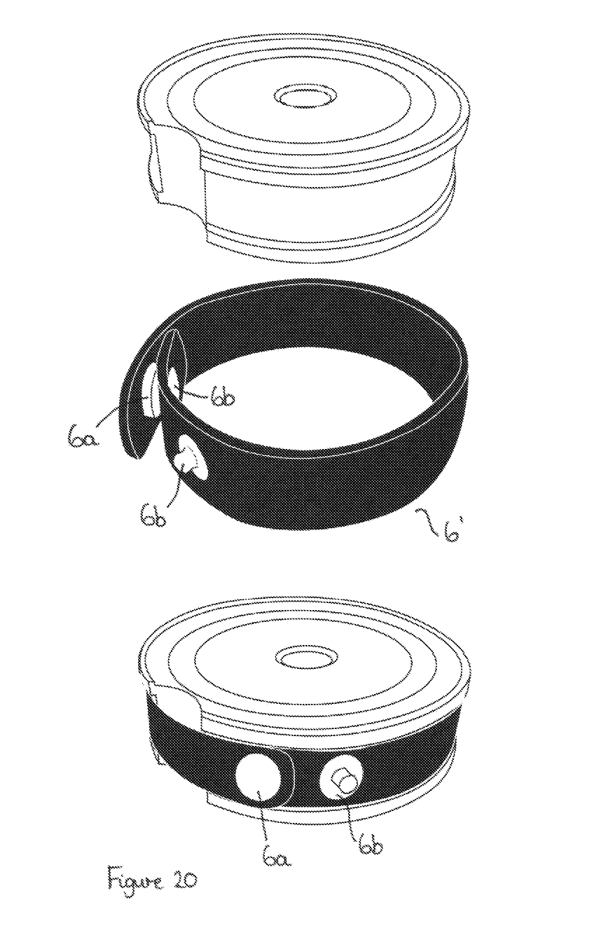

FIGS. 16 to 18 illustrate yet another embodiment of a trophy 1 of the invention. In this embodiment the trophy 1 includes a support 12 on which another part of the trophy, in this case a football boot 13, is mounted. The support 12 has a channel 4 bound by lips 5a, 5b provided in the perimeter thereof. As can be seen from FIGS. 17 and 18, an indent 3 provides for the insertion of a finger beneath the band 6 so that it may be removed from the channel 4 and hence the trophy 1.

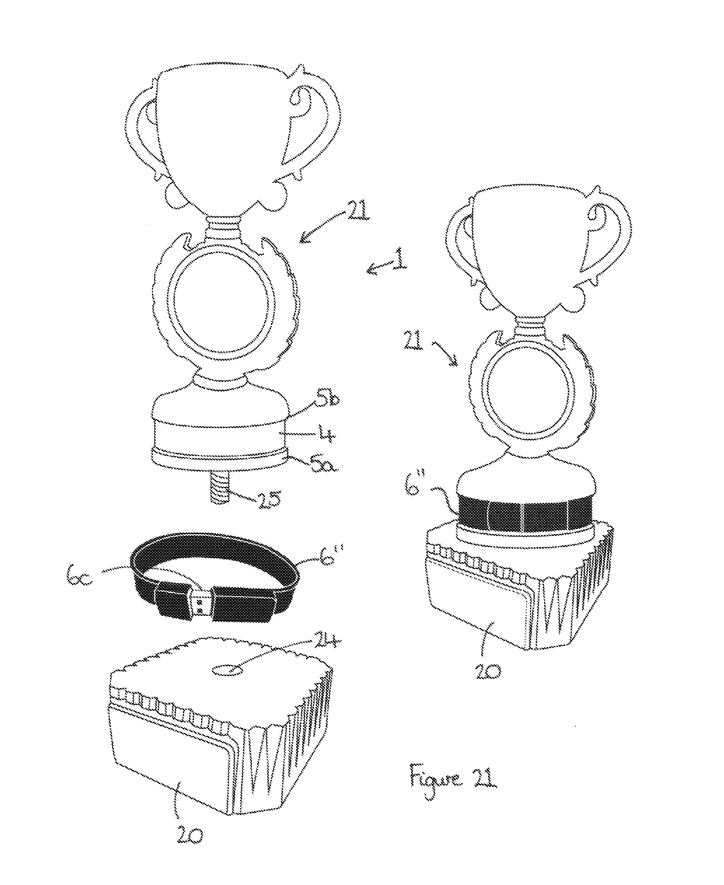

Referring now to FIG. 19, the trophy 1 includes a plinth 20, a main trophy body 21 and an intermediate component 22. The intermediate component 22 is configured to receive a band thereon and to that end includes a channel 4, bounded by lower and upper lips 5a, 5b and an indent 3. The band 6 sits in the channel 4 as described with reference to the drawings described above, the indent providing for insertion of a finger behind the band for removal of the band from the channel 4. The intermediate component 22 is attachable to both the plinth 20 and the trophy body 21. The trophy body 21 may include a threaded rod (as in the embodiment illustrated in FIG. 21) which passes through a hole 23 into a corresponding internally threaded hole (not shown) in the plinth 20. Of course, the rod need not be threaded and could be attached to the plinth by adhesive or simply the fit of the rod in the hole in the plinth 20.

FIG. 20 illustrates the intermediate component 22 shown in FIG. 19, but instead of the band 6 being a continuous band that is stretched to attach to the intermediate component 22, the band 6′ is provided with fastener elements 6a, 6b which co-operate to fasten the band 6′ in position in the channel 4. In the illustrated example two fastener elements 6b are provided, which allows the band 6′ to form two different lengths. This configuration is useful where it is desirable to use a band material of limited stretching properties, or where it is desirable to use the same band with trophies or trophy parts of such different size that the size difference cannot be taken up by the ability of a band to stretch.

FIG. 21 illustrates another embodiment of the invention. In this embodiment the band 6″ sits in a channel 4 that is formed in a lower part of the trophy body 21. A threaded bar 25 extends from the base of the trophy body 21 and engages an internally threaded hole 24 in a plinth 20. The band 6″ includes an electronic device that in this embodiment includes a USB memory device 6c. The type of electronic device housed in the band 6c is not limited to a memory device. Other devices could be used that sense parameters of a wearer of such a band, for example: pulse, heart rate, position (if the device includes a GPS positioned), speed of motion, etc.

By providing the position for the band on a separate component many different configurations of trophy can be formed using a common component for location of the band. This may improve manufacturing efficiency.

The provision of an indent for receiving a part of a finger allows the stretchable band to be removed from the trophy easily. The provision of a channel 4 indicates where the stretchable band 6 is to be mounted on the trophy, and the provision of lips or walls assists in the positioning of the band and in ensuring that the band lies correctly on the trophy.

The combination of a trophy with a removable stretchable band allows a common trophy to be utilized with multiple different styles and/or colors of stretchable band. This provides for more streamlined manufacture and for lower amounts of stock to be held. Furthermore, the winner of the trophy is provided not only with a trophy, but also a stretchable band which may be worn about the person, providing a constant reminder of the individual's success.

1. A trophy having a stretchable band removably mounted thereon, the trophy comprising indicia indicating a position where the stretchable band is to be mounted on the trophy and an element providing for lifting of the stretchable band from the trophy.

2. A trophy according to claim 1, wherein the element providing for lifting of the stretchable band from the trophy is an indent.

3. A trophy according to claim 1, wherein the stretchable band is a continuous stretchable band.

4. A trophy according to claim 3, wherein the stretchable band is a silicone band.

5. A trophy according to claim 1, wherein the stretchable band has at least one adornment provided thereon.

6. A trophy according to claim 5, wherein the at least one adornment is one of: a letter, a symbol, a multiplicity of letters, a multiplicity of symbols, a combination of a letter and a symbol, and a combination of a multiplicity of letters and a multiplicity of symbols.

7. A trophy according to claim 5, wherein the at least one adornment is one of: moulded integrally with the band, and printed thereon.

8. A trophy according to claim 7, wherein the indicia is in the form of a line, or a plurality of spaced apart lines.

9. A trophy according to claim 1, wherein the indicia is in the form of a plurality of spaced apart lines, each line of the plurality of spaced apart lines lying parallel with one another.

10. A trophy according to claim 1, wherein the trophy includes a band seat, the indicia comprising a part of the band seat.

11. A trophy according to claim 10, wherein the indicia is in the form of raised portions.

12. A trophy according to claim 11, wherein the raised portions and the band seat form a channel extending around at least a part of the trophy, the channel configured to receive the stretchable band.

13. A trophy according to claim 12, wherein the channel is formed in one of: a base of the trophy, an upper part of the trophy, a mid part of the trophy, a rear part of the trophy and a projecting a part of the trophy.

14. A trophy according to claim 1, wherein said indicia indicating the position where the stretchable band is to be mounted on the trophy and the element providing for lifting of the band from the trophy, are comprised in a component that is attachable to at least one other part of the trophy.

15. A trophy according to claim 14, wherein the component is attachable to two different parts of the trophy.

16. A trophy according to claim 14, wherein the component includes one of a male and female coupling.

17. A trophy according to claim 14, wherein the component is a one piece plastic moulding.

18. A trophy according to claim 1, wherein the stretchable band is configured to be mounted to the trophy under tension.
